(19) United States
(12) Patent Application Publication
(10) Pub. No.: US 2008/0023479 A1
(43) Pub. Date: Jan. 31, 2008

(54) Adjustable animal feeder

(76) Inventor: Abbas Sadriwalla, Ft. Lauderdale, FL (US)

Correspondence Address: RICHARD S. ROSS, ESQ., 4801 S. UNIVERSITY DR., # 237, FT. LAUDERDALE, FL, 33328, US

(21) Appl. No.: 11/541,411

(22) Filed: Oct. 2, 2006

Related U.S. Application Data
(60) Provisional application No. 60/820,234, filed on Jul. 25, 2006.

(51) Int. Cl. B65D 25/24

(52) U.S. Cl. 220/480

(57) ABSTRACT

An apparatus for holding food for a quadruped is disclosed. The apparatus includes at least one vertical element to which the concave element is coupled. The apparatus further includes at least one adjustable fastener for fastening the concave element to the at least one vertical element, wherein the at least one adjustable fastener can be unfastened to allow the concave element to slide vertically along the at least one vertical element. The apparatus further includes a securing mechanism for securing the at least one vertical element to a structure for supporting the apparatus.

### CROSS-REFERENCE TO RELATED APPLICATIONS

The present patent application claims priority to U.S. provisional patent application Ser. No. 60/820,234 filed on Jul. 25, 2006. U.S. provisional patent application Ser. No. 60/820,234 is hereby incorporated by reference in its entirety.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### FIELD OF THE INVENTION

The invention disclosed broadly relates to the field of pet care, and more particularly relates to the field of feeding solutions for pets.

### BACKGROUND OF THE INVENTION

According to the American Veterinary Medical Association, there are more than 60 million pet dogs in the U.S. and nearly 70 million pet cats. Further, Americans spent 34.4 billion dollars on their pets in 2004, meaning that pet-related spending has doubled in the last 10 years in the US. Most notably, Americans spent $8.2 billion for veterinarian care. As the veterinary care industry continues to grow in the U.S., so does Americans' awareness of pet care.

Small animals kept in the home, i.e., pets, are typically fed in a bowls or bowls. Pet owners usually fill a bowl with water and/or food and simply place the bowl on the floor for the pet to eat. For small animals such as cats and smaller dogs, this arrangement is appropriate. For taller animals such as adult German shepherds or Great Danes, however, a bowl located on the floor may be uncomfortable for the animal and may cause strain on the animal's neck and back as he must extend his head downwards when eating. For this reason, veterinarians today are recommending that food and water bowls for taller animals are placed on an elevated platform so as to raise the level of the bowl and reduce strain on the animal's neck and back. Finding an appropriate platform, however, can be difficult, since animals come in varying shapes and heights. Further, space is at a premium in pet owners' homes and therefore there may be very little room to dedicate to an eating platform for a pet. Lastly, pets grow and therefore their height may vary over time, which results in the pet outgrowing a platform and necessitating a new one. This can be expense and time consuming.

Therefore, a need exists to overcome the problems with the prior art as discussed above, and particularly for a safer and more ergonomic way to provide food to small animals.

### SUMMARY OF THE INVENTION

Briefly, according to an embodiment of the present invention, an apparatus for holding food for a quadruped is disclosed. The apparatus includes at least one vertical element to which the concave element is coupled. The apparatus further includes at least one adjustable fastener for fastening the concave element to the at least one vertical element, wherein the at least one adjustable fastener can be unfastened to allow the concave element to slide vertically along the at least one vertical element. The apparatus further includes a securing mechanism for securing the at least one vertical element to a structure for supporting the apparatus.

In another embodiment of the present invention, an apparatus for holding food for a quadruped is disclosed. The apparatus includes a first vertical rod and a second vertical rod coupled with the first vertical rod. The apparatus further includes a bowl for holding food, wherein the bowl is coupled on a first side to the first vertical rod and coupled on a second side to the second vertical rod. The apparatus further includes a first adjustable fastener for fastening the first side of the bowl to the first vertical rod and a second adjustable fastener for fastening the second side of the bowl to the second vertical rod, wherein the first and second adjustable fasteners can be unfastened to allow the bowl to slide vertically along the first and second vertical rods. The apparatus further includes a securing mechanism for securing the first and second vertical rods to a structure for supporting the apparatus.

In another embodiment of the present invention, an apparatus for holding food for a quadruped is disclosed. The apparatus includes a bowl for holding food and a loop formed from an elongated element, wherein the loop comprises a first vertical element on a first side and a second vertical element on a second side. The apparatus further includes a first adjustable fastener for fastening a first side of the bowl to the first vertical element and a second adjustable fastener for fastening a second side of the bowl to the second vertical element, wherein the first and second adjustable fasteners can be unfastened to allow the bowl to slide vertically along the first and second vertical elements. The apparatus further includes a securing mechanism for securing the first and second vertical rods to a structure for supporting the apparatus.

The foregoing and other features and advantages of the present invention will be apparent from the following more particular description of the preferred embodiments of the invention, as illustrated in the accompanying drawings.

### BRIEF DESCRIPTION OF THE DRAWINGS

The subject matter, which is regarded as the invention, is particularly pointed out and distinctly claimed in the claims at the conclusion of the specification. The foregoing and other features and also the advantages of the invention will be apparent from the following detailed description taken in conjunction with the accompanying drawings. Additionally, the left-most digit of a reference number identifies the drawing in which the reference number first appears.

FIG. 1 is an illustration of a perspective view of the animal feeder, according to one embodiment of the present invention.

FIG. 2 is an illustration of a perspective view of the animal feeder of FIG. 1 along with a support structure, according to one embodiment of the present invention.

FIG. 3 is an illustration of a perspective view of an animal feeder, according to another embodiment of the present invention.

FIG. 4 is an illustration of a perspective view of an animal feeder, according to yet another embodiment of the present invention.

FIG. 5 is an illustration of a perspective view of an animal feeder, according to yet another embodiment of the present invention.

### DETAILED DESCRIPTION

The present invention provides a simplified apparatus for holding food for a quadruped, including an adjustable height feature. The apparatus includes at least one vertical element to which a concave element, such as a food bowl, is slidably attached. The apparatus further includes at least one adjustable fastener for fastening the bowl to the at least one vertical element, wherein the at least one adjustable fastener can be unfastened to allow the bowl to slide vertically along the at least one vertical element. Once the desired height of the bowl is reached, the at least one adjustable fastener is fastened. The apparatus further includes a securing mechanism, such as a hook, for securing the at least one vertical element to a structure for supporting the apparatus.

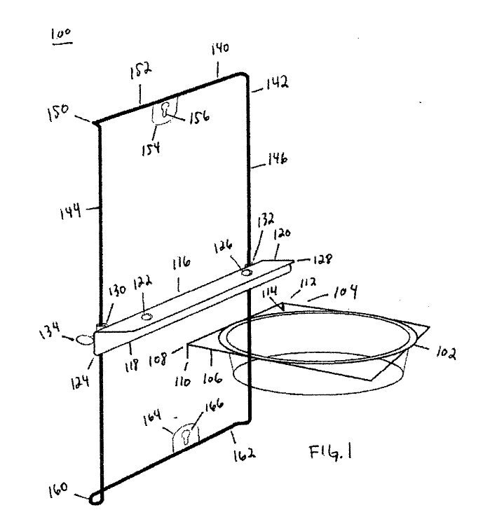

FIG. 1 is an illustration of a perspective view of an animal feeder 100, according to one embodiment of the present invention. FIG. 1 shows the animal feeder 100 includes a bowl 102 for holding solid food, such as dog or cat food, or liquid food, such as water. The bowl 102 can be 8 inches in diameter and 2 inches in depth. Along the rear 104 of the bowl 102 is a planar element 106 coupled to the rim of the bowl 102. The planar element 106 can be a square with each side measuring about 8 inches. On a left side 108 of the planar element 106 of the bowl 102 is a vertical protrusion 110 coupled to the left side 108 of the planar element 106 and extending downwards. On a right side 112 of the planar element 106 of the bowl 102 is a vertical protrusion 114 coupled to the right side 112 of the planar element 106 and extending downwards.

FIG. 1 further shows a horizontal L-bracket 116, which can be about 10.5 inches in length, includes a vertical planar element 118 coupled to a horizontal planar element 120. The horizontal planar element 120, which can be about 1 inch in depth, includes a first orifice 122 located on the left side 124 of the element 120 and a second orifice 126 located on the right side 128 of the element 120. The distance between the first and second orifices 122, 126 is identical or substantially equal to the distance between the protrusion 110 and the protrusion 114 of the bowl 102. Specifically, the protrusion 110 fits directly into orifice 122 and the protrusion 114 fits directly into orifice 126, so as to secure the bowl 102 to the L-bracket 116. Each protrusion can be further fastened to each orifice using a fastener, such as a tightening thumbscrew or an adhesive.

The vertical planar element 118, which can be about 1 inch in height, includes a first hollow cylinder 130 located on the left side 124 of the element 120 and a second hollow cylinder 132 located on the right side 128 of the element 120. Each hollow cylinder 130, 132 is coupled to the vertical planar element 118 via a fastening method such as welding or adhesive bonding. Alternatively, each hollow cylinder 130, 132 can be integrally manufactured from the same material as the vertical planar element 118. In another alternative, each hollow cylinder can include an orifice on its surface to allow access the hollow middle of the cylinder. This orifice allows a fastener, such as a thumbscrew 134, to be inserted so as to secure the cylinder to a rod or other element inserted into the cylinder.

FIG. 1 further includes a loop 140 comprised of a tubular element 142 such as a metallic rod or wire (which can be about 3/16 inch in diameter) that has been bent into a looped shape. The tubular element 142 includes a left side vertical element 144 and a right side vertical element 146. The height of the loop 140 (and therefore the length of left side vertical element 144 and right side vertical element 146) can be about 24 inches. It can be seen that left side vertical element 144 has been inserted into hollow cylinder 130. Further, hollow cylinder 130 has been further secured to the left side vertical element 144 using the thumbscrew 134. As the thumbscrew 134 is tightened, the hollow cylinder 130 is secured in place on left side vertical element 144 such that the hollow cylinder 130 cannot slide up and down along the left side vertical element 144. When the thumbscrew 134 is loosened, the hollow cylinder 130 is not secured in place on left side vertical element 144 and the hollow cylinder 130 can slide up and down along the length of left side vertical element 144 (24 inches, for example). In this way, a user can adjust the height of the L-bracket 116, and therefore the height of the bowl 102, and then secure the L-bracket 116 to the loop 140 using the thumbscrew 134.

It can further be seen that right side vertical element 146 has been inserted into hollow cylinder 132. Further, hollow cylinder 132 has been further secured to the right side vertical element 146 using a thumbscrew (not shown). As the thumbscrew is tightened, the hollow cylinder 132 is secured in place on right side vertical element 146 such that the hollow cylinder 132 cannot slide up and down along the right side vertical element 146. When the thumbscrew is loosened, the hollow cylinder 132 is not secured in place on right side vertical element 146 and the hollow cylinder 132 can slide up and down along the length of right side vertical element 146. In this way, a user can adjust the height of the L-bracket 116, and therefore the height of the bowl 102, and then secure the L-bracket 116 to the loop 140 using the thumbscrew.

FIG. 1 further shows an L-shaped portion 150 located on a top portion 152 of the loop 140. The L-shaped portion 150 is formed from a union of the left side vertical element 144 and the right vertical element 146 joining along the top portion 152 of the loop 140. The L-shaped portion 150 protrudes behind the loop 140 (about half an inch, for example) so as to provide a horizontal planar element that may be placed on a vertical plane of any one of a door, a cabinet door, a table, a wall, a fence, a stand and a shelf. By placing the L-shaped portion 150 on a support structure such as a cabinet door, the apparatus 100 is supported in an upright position near the floor so as to be accessible to a pet.

The L-shaped portion 150 further serves to keep the majority of the loop 140 away from the structure which supports the animal feeder 100. For example, if the animal feeder 100 is placed on top of a cabinet door, the L-shaped portion 150 serves to keep the loop 140 away from the vertical surface of the cabinet door such that the surface is not scratched or otherwise marred by the loop 140. Further, this feature allows for the hollow cylinders 130, 132 to be slid up and down during adjustment without marring the surface of the structure on which the animal feeder 100 is attached.

FIG. 1 further shows a planar element 154 coupled to the back of L-shaped portion 150. The planar element 154 extends downwards and includes an orifice 156 that may include a keyhole shaped opening. The planar element 154 can be used to fasten the loop 140 to the vertical surface of a supporting structure such as a cabinet door. Once the L-shaped portion 150 is placed on a support structure such as a cabinet door, a fastener (such as a screw) can be screwed through the orifice 156 and into the forward facing plane of the cabinet door, so as to prevent the animal feeder 100 from moving along the top of the cabinet door.

FIG. 1 further shows an L-shaped portion 160 located on a bottom portion 162 of the loop 140. The L-shaped portion 160 is formed from a union of the left side vertical element 144 and the right vertical element 146 joining along the bottom portion 162 of the loop 140. The L-shaped portion 160 protrudes behind the loop 140 (about half an inch, for example) so as to provide a horizontal planar element that may be placed on a vertical plane of any one of a door, a cabinet door, a table, a wall, a fence, a stand and a shelf. By placing the L-shaped portion 160 on a support structure such as a cabinet door, the apparatus 100 is supported in an upright position near the floor so as to be accessible to a pet. The L-shaped portion 160 further serves to keep the majority of the loop 140 away from the structure which supports the animal feeder 100.

FIG. 1 further shows a planar element 164 coupled to the back of L-shaped portion 160. The planar element 164 extends downwards and includes an orifice 166 that may include a keyhole shaped opening. The planar element 164 can be used to fasten the loop 140 to the vertical surface of a supporting structure such as a cabinet door. Once the L-shaped portion 160 is placed on a support structure such as a cabinet door, a fastener, (such as a screw) can be screwed through the orifice 166 and into the front surface of the cabinet door, so as to prevent the L-shaped portion 160 from moving along the bottom of the cabinet door.

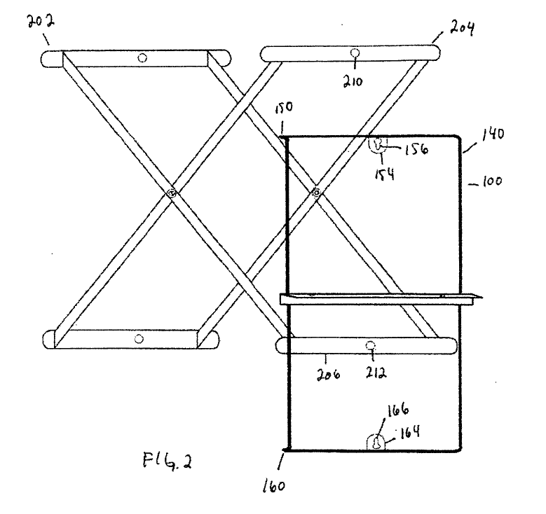

FIG. 2 is an illustration of a perspective view of the animal feeder 100 of FIG. 1 along with a support structure 202, according to one embodiment of the present invention. FIG. 2 shows how the animal feeder 100 can be attached to a supporting structure 202 so as to keep the feeder 100 in an upright position.

The L-shaped portion 150 of feeder 100 protrudes behind the loop 140 so as to provide a horizontal planar element that may be placed on a surface of the top 204 of the structure 202. By placing the L-shaped portion 150 on the support structure 202, the apparatus 100 is supported in an upright position near the floor so as to be accessible to a pet. Further, the planar element 154 can be used to fasten the loop 140 to the structure 202. Once the L-shaped portion 150 is placed on a surface of the top 204 of the structure 202, a fastener, such as a screw, can be screwed through the orifice 156 and into the orifice 210 of the structure 202, so as to prevent the L-shaped portion 150 from moving about along the top 204.

The L-shaped portion 160 of feeder 100 protrudes behind the loop 140 so as to provide a horizontal element that may be placed on a surface of the bottom 206 of the structure 202. By placing the L-shaped portion 160 on the support structure 202, the apparatus 100 is supported in an upright position near the floor so as to be accessible to a pet. Further, the planar element 164 can be used to fasten the loop 140 to the structure 202. Once the L-shaped portion 160 is placed on a surface of the bottom 206 of the structure 202, a fastener, such as a screw, can be screwed through the orifice 166 and into the orifice 212 of the structure 202, so as to prevent the L-shaped portion 160 from moving about along the bottom 206.

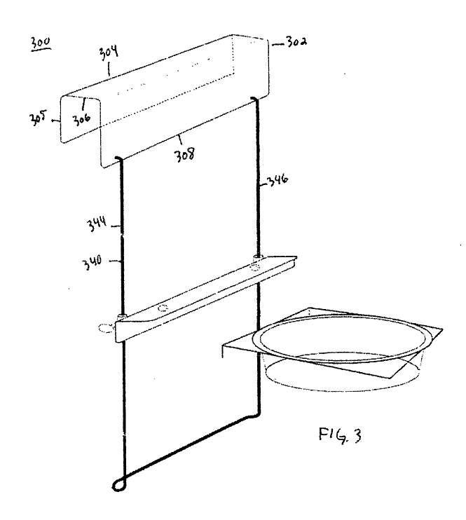

FIG. 3 is an illustration of a perspective view of an animal feeder 300, according to another embodiment of the present invention. FIG. 3 shows an animal feeder 300 similar to animal feeder 100 except that the top portion 302 of the feeder 300 provides an alternative method for attaching the animal feeder 300 to a supporting structure.

FIG. 3 shows a U-shaped portion 304 located on a top portion 302 of the loop 340. The U-shaped portion 304 is coupled with a top portion of the left side vertical element 344 and the right vertical element 346 along the top portion 302 of the loop 340. The U-shaped portion 304 is formed from a posterior planar element 305, which can be about 1 inch in height, a center planar element 306, which can be about ¾ inch deep, and an anterior planar element 308, which can be about 1.5 inches high. The U-shaped portion 304 protrudes behind the loop 340 so as to provide a downward facing hook that may be placed on the top of any one of a door, a cabinet door, a table, a stand and a shelf. By placing the U-shaped portion 304 on a support structure such as a cabinet door, the apparatus 300 is supported in an upright position near the floor so as to be accessible to a pet.

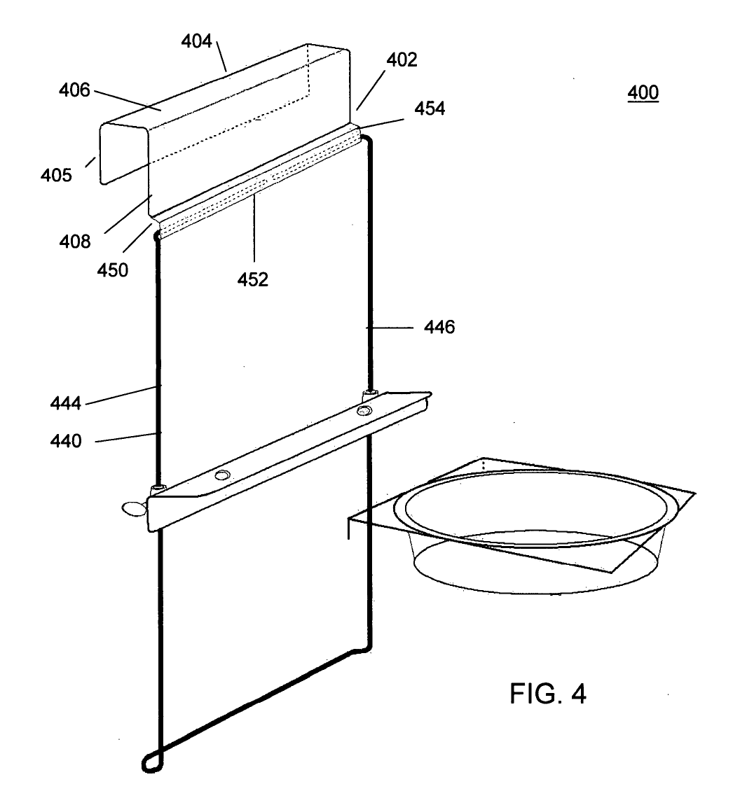

FIG. 4 is an illustration of a perspective view of an animal feeder 400, according to another embodiment of the present invention. FIG. 4 shows an animal feeder 400 similar to animal feeder 300 except that the top portion 402 of the feeder 400 provides an alternative method for attaching the loop 440 to the U-shaped portion 404.

FIG. 4 shows a U-shaped portion 404 located on a top portion 402 of the loop 440. The U-shaped portion 404 is coupled, via an L-shaped portion 454, with a top portion of the left side vertical element 444 and the right vertical element 446 along the top portion 402 of the loop 440. The L-shaped portion 454 is formed from a horizontal element 450 and a vertical element 452. The horizontal element 450 is coupled with the U-shaped portion 404. Further, the loop 440 is coupled with the vertical element 452. The purpose behind the L-shaped portion 454 is to keep the loop 440 away from the forward-facing surface of the supporting structure of the animal feeder 400. Thus, the forward-facing surface of the supporting structure, such as a cabinet, is kept free from marring or other scratches due to the use of the animal feeder 400.

The U-shaped portion 404 is formed from a posterior planar element 405, which can be about 1 inch in height, a center planar element 406, which can be about ¾ inch deep, and an anterior planar element 408, which can be about 1.5 inches high. The U-shaped portion 404 protrudes behind the loop 440 so as to provide a downward facing hook that may be placed on the top of any one of a door, a cabinet door, a table, a stand and a shelf. By placing the U-shaped portion 404 on a support structure such as a cabinet door, the apparatus 400 is supported in an upright position near the floor so as to be accessible to a pet.

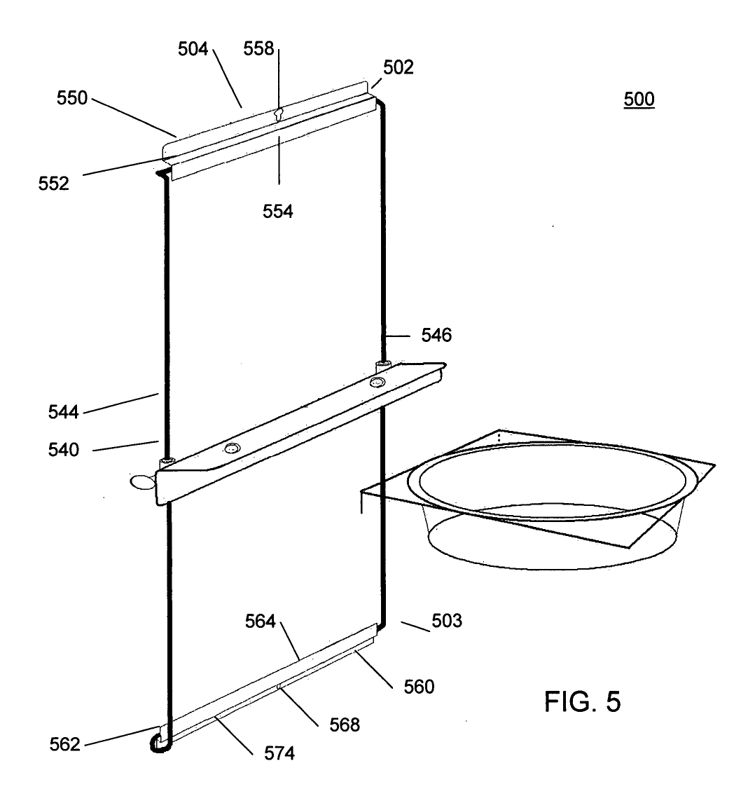

FIG. 5 is an illustration of a perspective view of an animal feeder 500, according to another embodiment of the present invention. FIG. 5 shows an animal feeder 500 similar to animal feeder 400 except that the top portion 502 of the feeder 500 provides an alternative method for attaching the loop 540 to the supporting structure.

FIG. 5 shows a segmented portion 504 located on a top portion 502 of the loop 540. The segmented portion 504 consists of a vertical element 550, a horizontal element 552 and another vertical element 554. The segmented portion 504 is coupled with a top portion of the left side vertical element 544 and the right vertical element 546 along the top portion 502 of the loop 540. Specifically, the vertical element 554 is coupled with the loop 540. The purpose behind the segmented portion 504 is to keep the loop 540 away from the forward-facing surface of the supporting structure of the animal feeder 500. Thus, the forward-facing surface of the supporting structure, such as a cabinet, is kept free from marring or other scratches due to the use of the animal feeder 500.

FIG. 5 further shows an orifice 558 in vertical element 550 that may include a keyhole shaped opening. The orifice 558 can be used to fasten the segmented portion 504 to the vertical surface of a supporting structure such as a cabinet door. Once the segmented portion 504 is placed on a support structure such as a cabinet door, a fastener, (such as a screw) can be screwed through the orifice 558 and into the front surface of the cabinet door, so as to prevent the segmented portion 504 from moving along the bottom of the cabinet door.

FIG. 5 further shows a segmented portion 574 located on a bottom portion 503 of the loop 540. The segmented portion 574 consists of a vertical element 560, a horizontal element 562 and another vertical element 564. The segmented portion 574 is coupled with a bottom portion of the left side vertical element 544 and the right vertical element 546 along the bottom portion 503 of the loop 540. Specifically, the vertical element 564 is coupled with the loop 540. FIG. 5 further shows an orifice 568 in vertical element 560 that may include a keyhole shaped opening. The orifice 568 can be used to fasten the segmented portion 574 to the vertical surface of a supporting structure such as a cabinet door.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

We claim:

1. An apparatus for holding food for a quadruped, comprising:
a concave element for holding solid or liquid food;
at least one vertical element to which the concave element is coupled;
at least one adjustable fastener for fastening the concave element to the at least one vertical element, wherein the at least one adjustable fastener can be unfastened to allow the concave element to slide vertically along the at least one vertical element; and
a securing mechanism for securing the at least one vertical element to a structure for supporting the apparatus.

2. The apparatus of claim 1, wherein the concave element comprises a bowl.

3. The apparatus of claim 2, wherein the at least one vertical element comprises two vertical rods.

4. The apparatus of claim 3, wherein the at least one adjustable fastener comprises two hollow cylindrical elements, wherein each cylindrical element is disposed around one of the two vertical rods, and wherein each cylindrical element includes a screw that secures the cylindrical element to a vertical rod.

5. The apparatus of claim 3, wherein the securing mechanism comprises a hook coupled to a top portion of the at least one vertical element, wherein the hook can be secured to a structure for supporting the apparatus.

6. The apparatus of claim 3, wherein the securing mechanism comprises a hook formed from a union of a top portion of the two vertical rods, wherein the hook can be secured to a structure for supporting the apparatus.

7. The apparatus of claim 3, wherein the securing mechanism comprises a hook formed from a U-shaped planar element coupled to a top portion of the two vertical rods, wherein the hook can be secured to a structure for supporting the apparatus.

8. The apparatus of claim 3, further comprising:
at least one planar element coupled with the two vertical rods, wherein the at least one planar element includes an orifice for use with a fastener so as to fasten the apparatus to the structure supporting the apparatus.

9. An apparatus for holding food for a quadruped, comprising:
a first vertical rod;
a second vertical rod coupled with the first vertical rod;
a bowl for holding food, wherein the bowl is coupled on a first side to the first vertical rod and coupled on a second side to the second vertical rod;
a first adjustable fastener for fastening the first side of the bowl to the first vertical rod;
a second adjustable fastener for fastening the second side of the bowl to the second vertical rod, wherein the first and second adjustable fasteners can be unfastened to allow the bowl to slide vertically along the first and second vertical rods; and
a securing mechanism for securing the first and second vertical rods to a structure for supporting the apparatus.

10. The apparatus of claim 9, wherein the first and second vertical rods comprise metallic rods.

11. The apparatus of claim 10, wherein the first adjustable fastener comprises a hollow cylindrical element disposed around the first vertical rod, wherein the cylindrical element includes a screw that secures the cylindrical element to the first vertical rod.

12. The apparatus of claim 11, wherein the second adjustable fastener comprises a hollow cylindrical element disposed around the second vertical rod, wherein the cylindrical element includes a screw that secures the cylindrical element to the second vertical rod.

13. The apparatus of claim 12, wherein the screw comprises a thumbscrew.

14. The apparatus of claim 9, wherein the securing mechanism comprises a hook formed from a union of a top portion of the first and second vertical rods, wherein the hook can be secured to a structure for supporting the apparatus.

15. The apparatus of claim 14, wherein the structure for supporting the apparatus comprises any one of a door, a cabinet door, a table, a stand and a shelf.

16. An apparatus for holding food for a quadruped, comprising:
a bowl for holding food;
a loop formed from a elongated element, wherein the loop comprises a first vertical element on a first side and a second vertical element on a second side;
a first adjustable fastener for fastening a first side of the bowl to the first vertical element;
a second adjustable fastener for fastening a second side of the bowl to the second vertical element, wherein the first and second adjustable fasteners can be unfastened to allow the bowl to slide vertically along the first and second vertical elements; and
a securing mechanism for securing the first and second vertical rods to a structure for supporting the apparatus.

17. The apparatus of claim 16, wherein the first and second vertical element each comprise a vertical rod.

18. The apparatus of claim 17, wherein the first and second adjustable fasteners each comprise a hollow cylindrical element for placement around a vertical element, wherein the cylindrical element includes a screw that secures the cylindrical element to the vertical element.

19. The apparatus of claim 18, wherein the securing mechanism comprises a hook formed from a top portion of the loop, wherein the hook can be secured to a structure for supporting the apparatus.

20. The apparatus of claim 19, wherein the structure for supporting the apparatus comprises a door, a cabinet door, a table, a stand and a shelf.
